(19) United States
(12) Patent Application Publication
(10) Pub. No.: US 2026/0084637 A1
(43) Pub. Date: Mar. 26, 2026

(54) SYSTEM, APPARATUS, AND METHOD

(71) Applicant: TOYOTA JIDOSHA KABUSHIKI KAISHA, Toyota-shi (JP)

(72) Inventors: Mitsuhiro MIURA, Toyota-shi (JP); Yoshiaki TOMATSU, Toyoake-shi (JP)

(73) Assignee: TOYOTA JIDOSHA KABUSHIKI KAISHA, Toyota-shi (JP)

(21) Appl. No.: 19/276,411

(22) Filed: Jul. 22, 2025

(30) Foreign Application Priority Data
Sep. 20, 2024 (JP) 2024-164431

(51) Int. Cl. B60R 16/023; B60K 35/28; G06V 20/59

(52) U.S. Cl. CPC B60R 16/0232; B60K 35/28; G06V 20/59

(57) ABSTRACT

An operation management system for a vehicle with multiple persons on board includes an imager configured to image the interior of the vehicle, a person detector configured to determine, based on an image captured by the imager, whether there is a person in a detection area set in the vehicle in advance, and upon determining that there is a person in the detection area, determine whether a predetermined condition for safety is met, and a notifier configured to notify a monitoring staff when the person detector has determined that there is a person in the detection area. The notifier does not notify the monitoring staff when the person detector has determined that there is a person in the detection area and that the predetermined condition for safety is met.

### CROSS-REFERENCE TO RELATED APPLICATION

This application claims priority to Japanese Patent Application No. 2024-164431 filed on Sep. 20, 2024, the entire contents of which are incorporated herein by reference.

### TECHNICAL FIELD

The present disclosure relates to a system, an apparatus, and a method.

### BACKGROUND

Technology for assisting safety confirmation when doors of vehicles are opened or closed automatically is known. For example, Patent Literature (PTL) 1 discloses technology for setting up a catch detection area for objects being caught in a door and a fall detection area for objects falling down through a door, by forming a scan range along an outer side surface of a train vehicle using an optical scanner mounted on the outer side surface of the train vehicle.

### CITATION LIST

### Patent Literature

PTL 1: JP 2022-134452 A

### SUMMARY

Generally, a catch detection area or fall detection area for objects is set with a safety width. Therefore, even in a case in which a passenger is located in the detection area, safety may be ensured when a condition, e.g., the passenger is holding onto a handrail is met. However, in the conventional technology, the opening or closing of an automatic door is controlled according to whether a passenger is located in the detection area, so the opening or closing of the automatic door may be stopped even though the passenger in the detection area is in a safe condition. Therefore, there is room for improvement in technology for assisting safety confirmation when doors of vehicles are opened and closed automatically.

It would be helpful to improve technology for assisting safety confirmation when doors of vehicles are opened and closed automatically.

A system according to one embodiment of the present disclosure is a system for managing an operation of a vehicle with multiple persons on board, the system including:
an imager configured to image the interior of the vehicle;

a person detector configured to determine, based on an image captured by the imager, whether there is a person in a detection area set in the vehicle in advance, and upon determining that there is a person in the detection area, determine whether a predetermined condition for safety is met; and
a notifier configured to notify a monitoring staff when the person detector has determined that there is a person in the detection area,
wherein the notifier does not notify the monitoring staff when the person detector has determined that there is a person in the detection area and that the predetermined condition for safety is met.

According to one embodiment of the present disclosure, technology for assisting safety confirmation when doors of vehicles are opened and closed automatically is improved.

### BRIEF DESCRIPTION OF THE DRAWINGS

In the accompanying drawings:

FIG. 1 is a block diagram illustrating a schematic configuration of an operation management system according to an embodiment of the present disclosure;

FIG. 2 is a flowchart illustrating an example of operations when doors of a vehicle are opened and closed automatically, according to the embodiment of the present disclosure;

FIG. 3 is a diagram illustrating a state in which there is a passenger in a detection area, according to the embodiment of the present disclosure;

FIG. 4 is a diagram illustrating a state in which the passenger meets a predetermined condition for safety, according to the embodiment of the present disclosure;

FIG. 5 is a diagram illustrating equipment in the vehicle according to the embodiment of the present disclosure;

FIG. 6 is a diagram illustrating an example of indication of the detection area according to the embodiment of the present disclosure; and

FIG. 7 is a diagram illustrating a configuration of the vehicle according to the embodiment of the present disclosure.

### DETAILED DESCRIPTION

Hereinafter, an embodiment of the present disclosure will be described.

### Outline of Embodiment

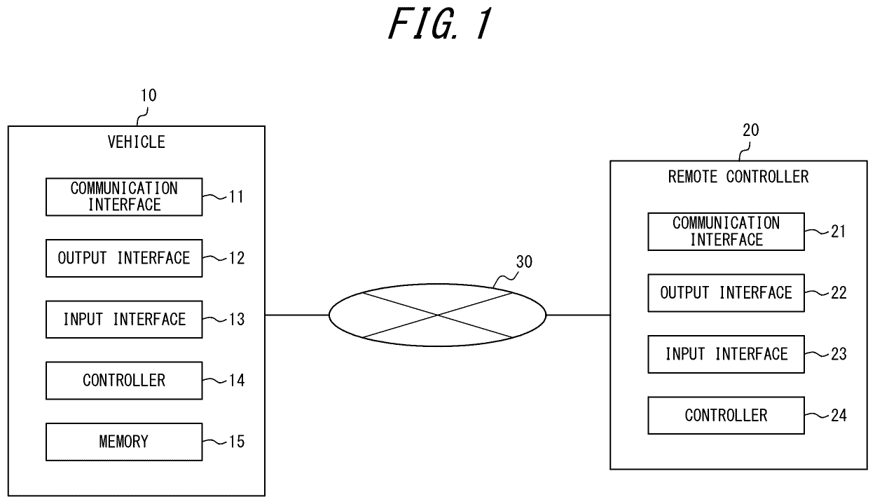

An outline of a vehicle according to the embodiment of the present disclosure will be described with reference to FIG. 1. A vehicle 10 includes a communication interface 11, an output interface 12, an input interface 13, a controller 14, and a memory 15. The vehicle 10 may be a remotely controlled vehicle. In such a case, the vehicle 10 and a remove controller 20 are communicably connected to a network 30 including, for example, the Internet, a mobile communication network, and the like. The remote controller 20 includes a communication interface 21, an output interface 22, an input interface 23, and a controller 24.

The vehicle 10 is an automobile, for example, but is not limited to this and may be any vehicle. The automobile is, for example, a Battery Electric Vehicle (BEV), a Hybrid Electric Vehicle (HEV), a Plug-in Hybrid Electric Vehicle (PHEV), a Fuel Cell Electric Vehicle (FCEV), or the like, but is not limited to these. The number of vehicles 10 included in an operation management system may be freely determined.

The vehicle 10 according to the present embodiment is provided with an imaging device 50 that images a detection area 33 including a handrail 32 in the vehicle 10, a door 31 that is opened and closed automatically, and a notifier that notifies a monitoring staff who monitors the interior of the vehicle 10. When the vehicle 10 is stopped and the door 31 is opened and closed, the imaging device 50 images the detection area 33 including the handrail 32 in the vehicle 10. Based on an image captured by the imaging device 50, the controller 14 determines the presence or absence of a passenger 34 in the detection area 33. Upon detecting a passenger 34 in the detection area 33, the controller 14 determines whether the passenger 34 meets a predetermined condition for safety. When the passenger 34 does not meet the predetermined condition for safety, the controller 14 notifies the monitoring staff via the communication interface 11, and stops the door 31 from being opened or closed. On the other hand, when no passenger 34 has been detected in the detection area 33, or although a passenger 34 has been detected in the detection area 33, the passenger 34 meets the predetermined condition for safety, the controller 14 does not notify the monitoring staff and opens or closes the door 31. The controller 14 may display, on an in-vehicle monitoring display 51, the detection result in the detection area 33 on the image of the detection area 33.

First, an outline of the present embodiment will be described, and details thereof will be described later. An operation management system for a vehicle with multiple persons on board includes an imager that images the interior of the vehicle, a person detector that determines, based on an image captured by the imager, whether there is a person in a detection area 33 set in the vehicle in advance, and upon determining that there is a person in the detection area 33, determine whether a predetermined condition for safety is met, and a notifier configured to notify a monitoring staff when the person detector has determined that there is a person in the detection area 33. The notifier does not notify the monitoring staff when the person detector has determined that there is a person in the detection area 33 and that the predetermined condition for safety is met.

Thus, according to the present embodiment, even in a case in which it is determined that there is a person in the detection area 33, the monitoring staff is not notified when the predetermined condition for safety is met. Therefore, technology for operation management systems is improved in that it is possible to reduce workloads on a monitoring staff and prevent disruptions in operation schedules by eliminating unnecessary notifications to the monitoring staff.

Next, configurations of the operation management system will be described in detail.

An outline of the operation management system according to the embodiment of the present disclosure will be described with reference to FIG. 1. The operation management system includes a vehicle 10 and a remote controller 20. The vehicle 10 and the remote controller 20 are communicably connected to a network 30 including, for example, the Internet, a mobile communication network, and the like.

### Configuration of Vehicle 10

As illustrated in FIG. 1, the vehicle 10 includes a communication interface 11, an output interface 12, an input interface 13, a controller 14, and a memory 15.

The communication interface 11 includes an interface for communicating with external devices. The interface may be compliant with any wired communication standard or any wireless communication standard.

The output interface 12 includes at least one output device for outputting information. The output device is, for example, a display, a speaker, an indicator such as an LED, or the like, but is not limited to these. Alternatively, the output interface 12 may include an interface for connecting to an external output device.

The input interface 13 includes at least one input device for detecting user input. The input device is a physical key, a capacitive key, a pointing device such as a mouse, a touch screen integrally provided with a display of the output interface 12, a microphone for accepting audio input, or the like, for example, but is not limited to these. Alternatively, the input interface 13 may include an input interface for detecting user input via an external input device.

The controller 14 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The processor, the programmable circuit, and the dedicated circuit are hereinafter also referred to as “processor and the like” without particular distinction. The controller 14 controls operations of the entire vehicle 10.

The memory 15 includes one or more memories. The memories are, for example, semiconductor memories, magnetic memories, optical memories, or the like, but are not limited to these. The memories included in the memory 15 may each function as, for example, a main memory, an auxiliary memory, or a cache memory. The memory 15 stores any information used in operations of the vehicle 10. For example, the memory 15 may store a system program, an application program, embedded software, and the like.

In the present embodiment, the memory 15 stores an object detection AI that detects an object in a captured image, and a posture estimation AI that estimates the posture of the object. The object detection AI may include any object detection model, for example, R-CNN. The posture estimation AI may be, for example, any skeletal estimation model that estimates the posture from the skeleton of the object, i.e., a human.

### Configuration of Remote Controller 20

As illustrated in FIG. 1, the remote controller 20 includes a communication interface 21, an output interface 22, an input interface 23, and a controller 24.

The communication interface 21 includes an interface for communicating with external devices. The interface may be compliant with any wired communication standard or any wireless communication standard.

The output interface 22 includes at least one output device for outputting information. The output device is, for example, a display, a speaker, or the like, but is not limited to these. Alternatively, the output interface 22 may include an interface for connecting to an external output device.

The input interface 23 includes at least one input device for detecting user input. The input device is a physical key, a capacitive key, a pointing device such as a mouse, a touch screen integrally provided with a display of the output interface 22, a microphone for accepting audio input, or the like, for example, but is not limited to these. Alternatively, the input interface 23 may include an input interface for detecting user input via an external input device.

The controller 24 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The processor, the programmable circuit, and the dedicated circuit are hereinafter also referred to as “processor and the like” without particular distinction. The controller 24 controls operations of the entire vehicle 10, including the opening and closing of a door. When the vehicle 10 is controlled remotely, the operations of the entire vehicle 10, including the opening and closing of the door, are controlled remotely.

### Operation Flow of Vehicle 10

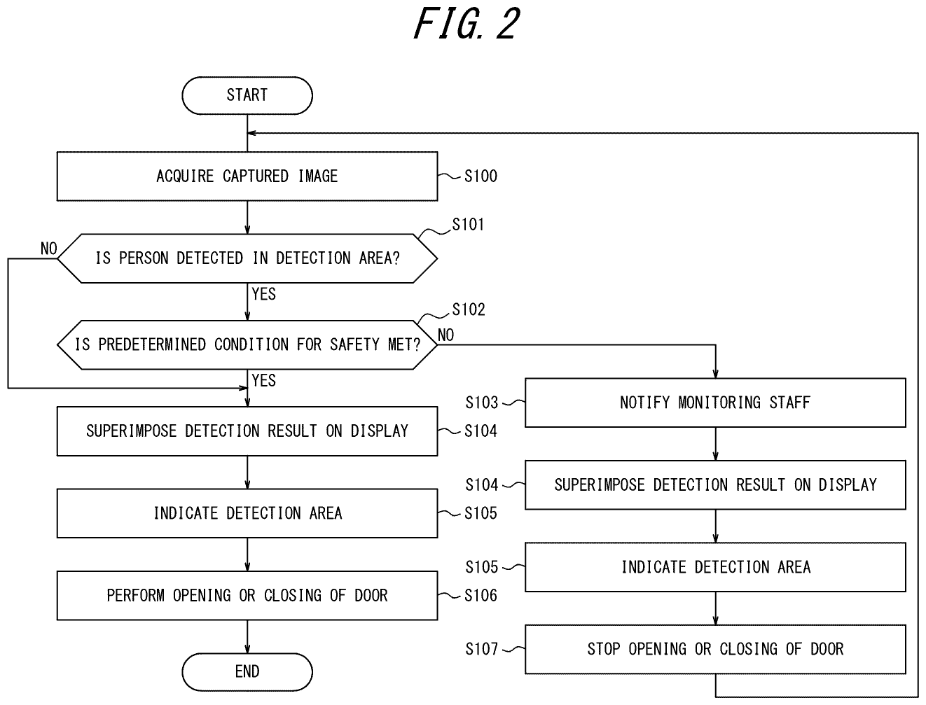

An operation flow of the vehicle 10 according to the present embodiment will be described with reference to FIG. 2.

Step S100: The interior of the vehicle 10 is imaged.

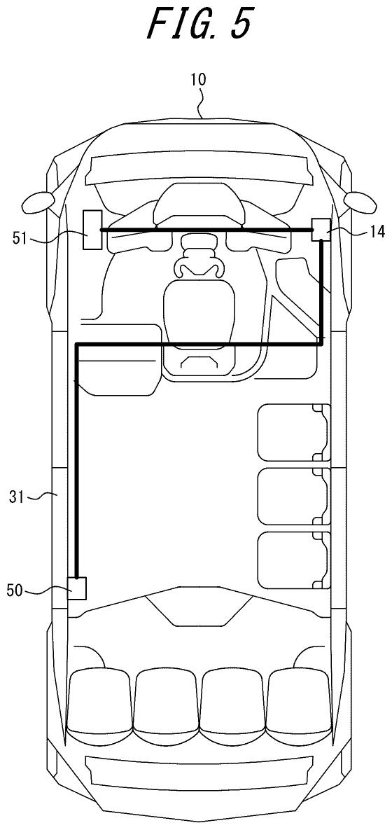

The vehicle 10, which can accommodate multiple passengers 34, is equipped with auxiliary equipment for standing passengers 34, such as a handrail 32, near a door 31. When the door 31 is opened or closed, an imaging device 50 images a detection area 33 including the handrail 32. The controller 14 acquires, via the communication interface 11, an image captured by the imaging device 50. The image captured by the imaging device 50 may be a moving image. The controller 14 acquires the latest frame of the image, which is the moving image, i.e., the latest still image that constitutes the moving image. In the example of FIG. 5, the imaging device 50 is installed near the door 31 of the vehicle 10, but may be installed at any position in the vehicle 10 so that the entire detection area 33, including the handrail 32, is imaged. The detection area 33 is described below.

Step S101: Based on the image captured by the imaging device 50, whether there is a person in the detection area 33, which is set in the vehicle 10 in advance, is determined.

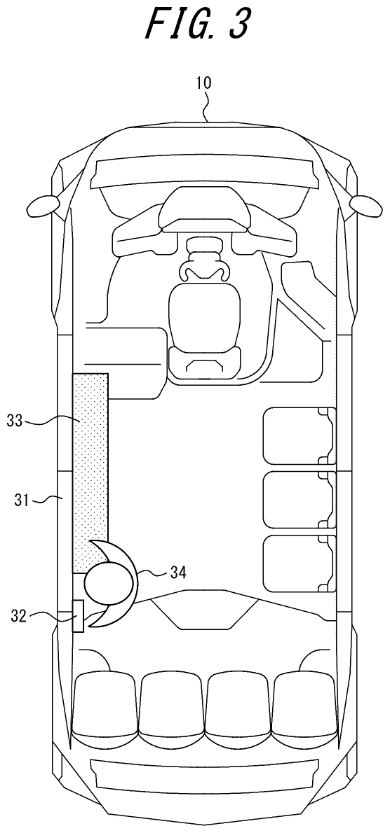

The controller 14 inputs the image, which is captured by the imaging device 50, via the communication interface 11 to the object detection AI stored in the memory 15. The object detection AI determines the presence or absence of a passenger 34 in the detection area 33. The detection area 33 is set in advance, as an area from which a passenger 34 is at risk of falling down or in which a passenger 34 is at risk of being caught in the door 31 when the door 31 is opened or closed. In the example of FIG. 3, the detection area 33 is rectangular, but any shape, such as an oval shape, can be adopted. As described below, the detection area 33 may include one or more detection areas, such as a first detection area 60 and a second detection area 61.

Step S102: When it has been determined based on the image captured by the imaging device 50 that there is a person in the detection area 33, whether a predetermined condition for safety is met is determined.

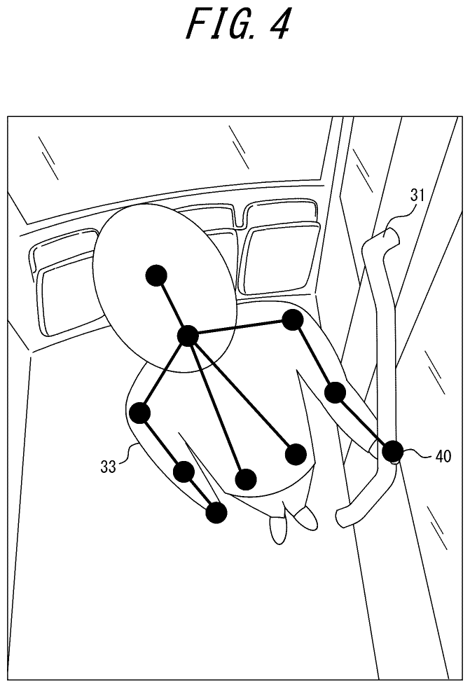

When it has been determined in step S101 that there is a passenger 34 in the detection area 33, step S102 is performed. The controller 14 inputs the image, which is captured by the imaging device 50, via the communication interface 11 to the posture estimation AI stored in the memory 15. The posture estimation AI estimates the posture of the passenger 34 in the detection area 33, and determines whether the predetermined condition for safety is met. Specifically, the predetermined condition for safety may be an act of the standing passenger 34 grasping the handrail 32 or any auxiliary equipment such as a suspension strap. In the example of FIG. 4, whether the hand 40 of the passenger 34 is griping the handrail 32 is estimated based on skeletal estimation, but any estimation technique can be employed. The passenger 34 who meets the predetermined condition for safety can be determined to have a sufficiently low risk of falling down from the vehicle 10 or being caught in the door 31 when the door 31 is opened or closed, even when the passenger 34 is in the detection area 33.

Step S103: When a person detector has determined that there is a person in the detection area 33, a monitoring staff is notified.

When it has been determined in step S102 that the predetermined condition for safety is not met, step S103 is performed. The vehicle 10 may have a monitoring staff to monitor the multiple passengers 34. The controller 14 determines the presence or absence of a passenger 34 in the detection area 33, and notifies the monitoring staff when the predetermined condition for safety is not met. A notification may be made via a speaker or the like. In addition, any method can be employed, such as receiving a notification on an in-vehicle monitoring display 51, which is described below. The monitoring staff may be on board the vehicle 10 or remotely control the vehicle 10 from outside. In the case of remote control, the monitoring staff may receive a notification regarding the vehicle 10 via the network 30. The monitoring staff can know in advance the presence or absence of a risk of a passenger 34 falling down from the vehicle 10 or being caught in the door 31 due to the opening or closing of the door 31. On the other hand, even in a case in which it has been determined that there is a passenger 34 in the detection area 33, the monitoring staff does not receive a notification when the predetermined condition for safety is met. Eliminating unnecessary notifications reduces a workload of the monitoring staff, and in remote control, allows a single monitoring staff member to monitor multiple vehicles. Eliminating unnecessary notifications can also prevent disruptions in an operation schedule for the vehicle 10.

Step S104: On the in-vehicle monitoring display 51 for the monitoring staff to monitor the interior of the vehicle 10, an image is displayed in which information having determined by the person detector whether there is a person in the detection area 33 and information having determined by the person detector whether the predetermined condition for safety is met are superimposed on the image captured by the imaging device 50.

As illustrated in FIG. 5, the vehicle 10 may be provided with the in-vehicle monitoring display 51 for the monitoring staff to monitor the interior of the vehicle 10. The controller 14 superimposes, on the image captured by the imaging device 50, the information having determined in step S101 whether there is a passenger 34 in the detection area 33, which is set in the vehicle 10 in advance, and when it has been determined that there is a passenger 34 in the detection area 33, the information having determined in step S102 whether the predetermined condition for safety is met. The controller 14 also displays the superimposed image on the in-vehicle monitoring display 51 via the communication interface 11. In the example of FIG. 5, the in-vehicle monitoring display 51 is installed at the front of the vehicle 10, but may be installed at any location that is visible to the monitoring staff. In remote control, the in-vehicle monitoring display 51 may be installed outside the vehicle 10, and the superimposed image may be displayed via the network 30. This enables the monitoring staff to easily grasp the presence or absence of a passenger 34 in the detection area 33 and whether the passenger 34 meets the predetermined condition for safety. This reduces a workload of the monitoring staff, and in remote control, allows a single monitoring staff member to monitor multiple vehicles.

Step S105: During an opening or closing operation of the door 31, a first detection area 60, which causes the opening or closing operation of the door 31 to stop even when the predetermined condition for safety is met, and a second detection area 61, which causes the opening or closing operation of the door 31 not to stop when the predetermined condition for safety is met, are indicated.

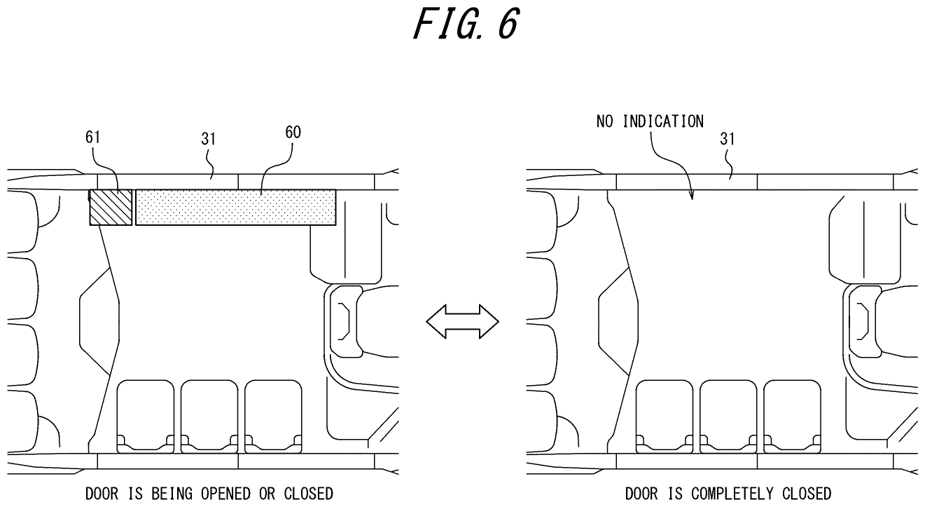

As described above, the detection area 33 is set in advance, as an area from which a passenger 34 is at risk of falling down or in which a passenger 34 is at risk of being caught in the door 31 when the door 31 is opened or closed. This detection area 33 may be indicated on a floor 70 in the vehicle 10 when the door 31 is opened or closed. As illustrated in FIG. 6, the detection area 33 may include one or more detection areas, such as the first detection area 60 and the second detection area 61. Here, the first detection area 60 is an area that causes the monitoring staff to be notified and causes the opening or closing operation of the door 31 to stop, even when the predetermined condition for safety is met. The second detection area 61 is an area that causes the opening or closing operation of the door 31 not to stop, when the predetermined condition for safety is met. Indicating the detection area 33 allows the passengers 34 to easily grasp an area from which the passengers 34 are at risk of falling down or in which the passengers 34 are at risk of being caught in the door 31. It is also expected to encourage a passenger 34 present in the detection area 33 to move out of the detection area 33. In the example of FIG. 6, the first detection area 60, the second detection area 61, and the detection area 33 are illustrated as rectangles, but any shape can be adopted, such as an oval shape that keeps the distance from the door 31 toward the center of the door 31.

Step S106: The opening or closing operation of the door 31 is not stopped.

Upon determining that there is a passenger 34 in the detection area 33 and that the predetermined condition for safety is met, the controller 14 does not stop the opening or closing operation of the door 31.

Step S107: The opening or closing operation of the door 31 is stopped.

Upon determining that there is a passenger 34 in the detection area 33 and that the predetermined condition for safety is not met, the controller 14 stops the opening or closing operation of the door 31. The operation then returns to step S100. The vehicle 10 repeats the operation flow illustrated in FIG. 2 until the door 31 is opened or closed in step S106.

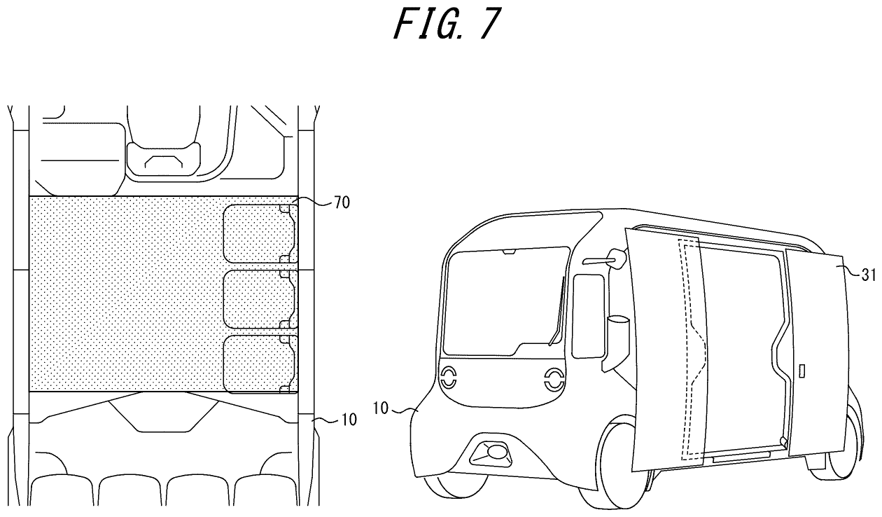

As illustrated in FIG. 7, the floor 70 in the vehicle 10 may be flat with no steps. The flat floor allows for efficient use of the interior of the vehicle 10, and makes it easier for the passengers 34, wheelchairs, and the like to get on and off the vehicle 10 or move around the vehicle 10. The door 31 of the vehicle 10 may be a sliding door that opens outward. The sliding door that opens outward allow for efficient use of the interior of the vehicle 10. The door 31 can be fully opened, thus making it easier for the passengers 34 to get on and off the vehicle 10 and for large luggage to be loaded onto and unloaded from the vehicle 10. In addition, the sliding door that opens outward can be expected to improve durability.

As described above, the operation management system for a vehicle with multiple persons on board includes an imager that images the interior of the vehicle, a person detector that determines, based on an image captured by the imager, whether there is a person in a detection area 33 set in the vehicle in advance, and upon determining that there is a person in the detection area 33, determine whether a predetermined condition for safety is met, and a notifier configured to notify a monitoring staff when the person detector has determined that there is a person in the detection area 33. The notifier does not notify the monitoring staff when the person detector has determined that there is a person in the detection area 33 and that the predetermined condition for safety is met.

According to such a configuration, even in a case in which it has been determined that there is a passenger 34 in the detection area 33, the monitoring staff is not notified when the predetermined condition for safety is met. Therefore, technology for operation management systems is improved in that it is possible to reduce workloads on a monitoring staff and prevent disruptions in operation schedules by eliminating unnecessary notifications to the monitoring staff.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one, divided, or omitted.

For example, an embodiment in which the configuration and operations of the remote controller 20 in the above embodiment are distributed to multiple computers capable of communicating with each other can be implemented. For example, a navigation apparatus mounted in the vehicle 10 may be equipped with some or all of the components of the vehicle 10.

In the above embodiment, in step S103, the monitoring staff is notified when it has been determined that the predetermined condition for safety is not met. However, even when it has not been determined that there is a passenger 34 in the detection area 33 or when it has been determined that there is a passenger 34 in the detection area 33 and that the predetermined condition for safety is met, the monitoring staff may be notified that the door 31 is being opened or closed, or the like. The monitoring staff can thereby check the safety of the passengers 34, without relying solely on safety determination made by the operation management system of the vehicle 10.

In the above embodiment, in step S104, the same contents are superimposed on the in-vehicle monitoring display 51 in both the case of performing the opening or closing of the door 31 and the case of stopping the opening or closing of the door 31. However, the image superimposed on the in-vehicle monitoring display 51 may be changed between the case of performing the opening or closing of the door 31 and the case of stopping the opening or closing of the door 31. For example, when it has been determined that there is a passenger 34 in the detection area 33 and that the predetermined condition for safety is not met, an indication to direct attention to the monitoring staff may be displayed. Specifically, a warning message may be displayed or the passenger 34 may be displayed with a red frame or the like. This allows the monitoring staff to operate the vehicle 10 more safely.

In the above embodiment, in step S105, the detection area 33 is indicated in the same manner, in both the case of performing the opening or closing of the door 31 and the case of stopping the opening or closing of the door 31. The indication of the detection area 33 may be changed between the case of performing the opening or closing of the door 31 and the case of stopping the opening or closing of the door 31. For example, when it has not been determined that there is a passenger 34 in the detection area 33, or when it has been determined that there is a passenger 34 in the detection area 33 and the predetermined condition for safety is met, the detection area 33 may not be indicated, or the detection area 33 may be indicated in blue or green, which gives an impression of security, calmness, or the like. On the other hand, when it has been determined that there is a passenger 34 in the detection area 33 and that the predetermined condition for safety is not met, the detection area 33 may be indicated in red or yellow to alert the passenger 34. Only the first detection area 60, of the detection area 33, may be indicated. This eliminates unnecessary notifications to the monitoring staff, thereby reducing a workload of the monitoring staff and preventing disruptions in an operation schedule.

In the above embodiment, in step S105, the detection area 33 is indicated during the opening or closing of the vehicle 10. However, the detection area 33 may be also indicated during traveling of the vehicle 10. A graphical user interface (GUI), which is operated by the monitoring staff, may be provided, so that the monitoring staff can select the timing of indicating the detection area 33. This allows the passengers 34 to be informed of the presence of the detection area 33 in advance and prevents disruptions in an operation schedule.

In the embodiment described above, when the opening or closing of the door 31 is stopped in step S107, the operation returns to step S100. However, not returning to step S100, the monitoring staff may determine the opening or closing of the door 31 and perform the opening or closing of the door 31. This prevents disruptions in an operation schedule.

The above embodiment has described a case in which there is a passenger 34 in the detection area 33, but for luggage or the like brought by a passenger 34, it may be determined whether there is luggage in the detection area 33 and whether a predetermined condition for safety is met. In such a case, the luggage may be detected by the object detection AI based on the captured image, and whether the luggage is held by a passenger 34 with a hand may be estimated by the posture estimation AI. This eliminates unnecessary notifications to the monitoring staff, thereby reducing a workload of the monitoring staff and preventing disruptions in an operation schedule.

The floor 70 in the vehicle 10 may have steps. The door 31 of the vehicle 10 may be a folding door or the like, and there may be multiple doors. When there are multiple doors, the opening or closing of the doors can be controlled on a door-by-door basis, by setting a detection area near each door and installing imaging devices 50 so that each detection area can be imaged. Therefore, the operation management system according to the present disclosure can be employed in current vehicles.

The imaging device 50 may be installed to image the detection area 33 from outside the vehicle 10, instead of inside the vehicle 10. The imaging device 50 may not be installed in the vehicle 10, but may be installed on a ceiling or the like at a station. This reduces the number of cameras, and allows the operation management system according to the present disclosure to be employed for vehicles that are not provided with imaging devices 50.

[Appendix 1] A system for managing an operation of a vehicle with multiple persons on board, the system comprising:
an imager configured to image an interior of the vehicle;
a person detector configured to determine, based on an image captured by the imager, whether there is a person in a detection area set in the vehicle in advance, and upon determining that there is a person in the detection area, determine whether a predetermined condition for safety is met; and
a notifier configured to notify a monitoring staff when the person detector has determined that there is a person in the detection area,
wherein the notifier does not notify the monitoring staff when the person detector has determined that there is a person in the detection area and that the predetermined condition for safety is met.

[Appendix 2] The system according to appendix 1, further comprising a door controller configured to stop an opening or closing operation of a door for the persons to get on and off the vehicle when the person detector has determined that there is a person in the detection area,
wherein the door controller is configured not to stop the opening or closing operation of the door when the person detector has determined that there is a person in the detection area and that the predetermined condition for safety is met.

[Appendix 3] The system according to appendix 1 or 2, further comprising a display for the monitoring staff to monitor the interior of the vehicle,
wherein the display is configured to display an image in which information having determined by the person detector whether there is a person in the detection area and information having determined by the person detector whether the predetermined condition for safety is met are superimposed on the image captured by the imager.

[Appendix 4] The system according to any one of appendices 1 to 3, wherein the detection area includes a first detection area that causes the opening or closing operation of the door to stop even when the predetermined condition for safety is met, and a second detection area that causes the opening or closing operation of the door not to stop when the predetermined condition for safety is met.

[Appendix 5] The system according to appendix 4, further comprising an indicator configured to indicate the first detection area and the second detection area during the opening or closing operation of the door.

[Appendix 6] The system according to any one of appendices 1 to 5, wherein a floor of the vehicle is flat, and the door is of a sliding structure that opens outward.

[Appendix 7] The system according to any one of appendices 1 to 6, wherein the vehicle is a remotely monitored automated driving vehicle.

[Appendix 8] An apparatus for managing an operation of a vehicle with multiple persons on board, the apparatus comprising:
an imager configured to image an interior of the vehicle;
a person detector configured to determine, based on an image captured by the imager, whether there is a person in a detection area set in the vehicle in advance, and upon determining that there is a person in the detection area, determine whether a predetermined condition for safety is met; and
a notifier configured to notify a monitoring staff when the person detector has determined that there is a person in the detection area,
wherein the notifier does not notify the monitoring staff when the person detector has determined that there is a person in the detection area and that the predetermined condition for safety is met.

[Appendix 9] The apparatus according to appendix 8, further comprising a door controller configured to stop an opening or closing operation of a door for the persons to get on and off the vehicle when the person detector has determined that there is a person in the detection area,
wherein the door controller is configured not to stop the opening or closing operation of the door when the person detector has determined that there is a person in the detection area and that the predetermined condition for safety is met.

[Appendix 10] The apparatus according to appendix 8 or 9, further comprising a display for the monitoring staff to monitor the interior of the vehicle,
wherein the display is configured to display an image in which information having determined by the person detector whether there is a person in the detection area and information having determined by the person detector whether the predetermined condition for safety is met are superimposed on the image captured by the imager.

[Appendix 11] The apparatus according to any one of appendices 8 to 10, wherein the detection area includes a first detection area that causes the opening or closing operation of the door to stop even when the predetermined condition for safety is met, and a second detection area that causes the opening or closing operation of the door not to stop when the predetermined condition for safety is met.

[Appendix 12] The apparatus according to appendix 11, further comprising an indicator configured to indicate the first detection area and the second detection area during the opening or closing operation of the door.

[Appendix 13] The apparatus according to any one of appendices 8 to 12, wherein a floor of the vehicle is flat, and the door is of a sliding structure that opens outward.

[Appendix 14] The apparatus according to any one of appendices 8 to 13, wherein the vehicle is a remotely monitored automated driving vehicle.

[Appendix 15] A method of executing an operation management apparatus for a vehicle with multiple persons on board, the method comprising:
imaging an interior of the vehicle;
determining, based on an image captured by the operation management apparatus, whether there is a person in a detection area set in the vehicle in advance, and upon determining that there is a person in the detection area, determining whether a predetermined condition for safety is met; and
notifying a monitoring staff when the operation management apparatus has determined that there is a person in the detection area,
wherein the operation management apparatus is configured not to notify the monitoring staff upon determining that there is a person in the detection area and that the predetermined condition for safety is met.

[Appendix 16] The method according to appendix 15, further comprising stopping an opening or closing operation of a door for the persons to get on and off the vehicle when the operation management apparatus has determined that there is a person in the detection area,
wherein the operation management apparatus is configured not to stop the opening or closing operation of the door upon determining that there is a person in the detection area and that the predetermined condition for safety is met.

[Appendix 17] The method according to appendix 15 or 16, further comprising monitoring, by the monitoring staff, the interior of the vehicle,
wherein the operation management apparatus is configured to display an image in which information having determined whether there is a person in the detection area and information having determined whether the predetermined condition for safety is met are superimposed on the captured image. [Appendix 18] The method according to any one of appendices 15 to 17, wherein
the detection area includes a first detection area that causes the opening or closing operation of the door to stop even when the predetermined condition for safety is met, and a second detection area that causes the opening or closing operation of the door not to stop when the predetermined condition for safety is met, and
the method further comprises indicating the first detection area and the second detection area during the opening or closing operation of the door.

[Appendix 19] The method according to any one of appendices 15 to 18, wherein a floor of the vehicle is flat, and the door is of a sliding structure that opens outward.

[Appendix 20] The method according to any one of appendices 15 to 19, wherein the vehicle is a remotely monitored automated driving vehicle.

1. A system for managing an operation of a vehicle with multiple persons on board, the system comprising:
an imager configured to image an interior of the vehicle;
a person detector configured to determine, based on an image captured by the imager, whether there is a person in a detection area set in the vehicle, and upon determining that there is a person in the detection area, determine whether a predetermined condition for safety is met; and
a notifier configured to make a notification when the person detector has determined that there is a person in the detection area,
wherein the notifier does not make a notification when the person detector has determined that there is a person in the detection area and that the predetermined condition for safety is met.

2. The system according to claim 1, further comprising a door controller configured to stop an opening or closing operation of a door for the persons to get on and off the vehicle when the person detector has determined that there is a person in the detection area,
wherein the door controller is configured not to stop the opening or closing operation of the door when the person detector has determined that there is a person in the detection area and that the predetermined condition for safety is met.

3. The system according to claim 2, further comprising a display configured to monitor the interior of the vehicle,
wherein the display is configured to display, on the image captured by the imager, information having determined by the person detector whether there is a person in the detection area and information having determined by the person detector whether the predetermined condition for safety is met.

4. The system according to claim 3, wherein information displayed on the display is an image in which the information having determined by the person detector whether there is a person in the detection area and the information having determined by the person detector whether the predetermined condition for safety is met are superimposed.

5. The system according to claim 4, wherein the detection area includes a first detection area that causes the opening or closing operation of the door to stop even when the predetermined condition for safety is met, and a second detection area that causes the opening or closing operation of the door not to stop when the predetermined condition for safety is met.

6. The system according to claim 5, further comprising an indicator configured to indicate the first detection area and the second detection area during the opening or closing operation of the door.

7. The system according to claim 6, wherein a floor of the vehicle is flat, and the door is of a sliding structure that opens outward.

8. The system according to claim 1, wherein the vehicle is a remotely monitored automated driving vehicle.

9. An apparatus for managing an operation of a vehicle with multiple persons on board, the apparatus comprising:
an imager configured to image an interior of the vehicle;
a person detector configured to determine, based on an image captured by the imager, whether there is a person in a detection area set in the vehicle, and upon determining that there is a person in the detection area, determine whether a predetermined condition for safety is met; and
a notifier configured to make a notification when the person detector has determined that there is a person in the detection area,
wherein the notifier does not make a notification when the person detector has determined that there is a person in the detection area and that the predetermined condition for safety is met.

10. The apparatus according to claim 9, further comprising a door controller configured to stop an opening or closing operation of a door for the persons to get on and off the vehicle when the person detector has determined that there is a person in the detection area,
wherein the door controller is configured not to stop the opening or closing operation of the door when the person detector has determined that there is a person in the detection area and that the predetermined condition for safety is met.

11. The apparatus according to claim 10, further comprising a display configured to monitor the interior of the vehicle,
wherein the display is configured to display, on the image captured by the imager, information having determined by the person detector whether there is a person in the detection area and information having determined by the person detector whether the predetermined condition for safety is met.

12. The apparatus according to claim 11, wherein information displayed on the display is an image in which the information having determined by the person detector whether there is a person in the detection area and the information having determined by the person detector whether the predetermined condition for safety is met are superimposed.

13. The apparatus according to claim 12, wherein the detection area includes a first detection area that causes the opening or closing operation of the door to stop even when the predetermined condition for safety is met, and a second detection area that causes the opening or closing operation of the door not to stop when the predetermined condition for safety is met.

14. The apparatus according to claim 13, further comprising an indicator configured to indicate the first detection area and the second detection area during the opening or closing operation of the door.

15. The apparatus according to claim 14, wherein a floor of the vehicle is flat, and the door is of a sliding structure that opens outward.

16. The apparatus according to claim 9, wherein the vehicle is a remotely monitored automated driving vehicle.

17. A method of executing an operation management apparatus for a vehicle with multiple persons on board, the method comprising:
imaging an interior of the vehicle;
determining, based on an image captured by the operation management apparatus, whether there is a person in a detection area set in the vehicle, and upon determining that there is a person in the detection area, determining whether a predetermined condition for safety is met; and
making a notification when the operation management apparatus has determined that there is a person in the detection area,
wherein the operation management apparatus is configured not to make a notification upon determining that there is a person in the detection area and that the predetermined condition for safety is met.

18. The method according to claim 17, further comprising stopping an opening or closing operation of a door for the persons to get on and off the vehicle when the operation management apparatus has determined that there is a person in the detection area,
wherein the operation management apparatus is configured not to stop the opening or closing operation of the door upon determining that there is a person in the detection area and that the predetermined condition for safety is met.

19. The method according to claim 18, further comprising monitoring the interior of the vehicle,
wherein the operation management apparatus is configured to display, on the captured image, information having determined whether there is a person in the detection area and information having determined whether the predetermined condition for safety is met.

20. The method according to claim 19, wherein information displayed on the display is an image in which the information having determined whether there is a person in the detection area and the information having determined whether the predetermined condition for safety is met are superimposed.

21. The method according to claim 20, wherein
the detection area includes a first detection area that causes the opening or closing operation of the door to stop even when the predetermined condition for safety is met, and a second detection area that causes the opening or closing operation of the door not to stop when the predetermined condition for safety is met, and
the method further comprises indicating the first detection area and the second detection area during the opening or closing operation of the door.

22. The method according to claim 21, wherein a floor of the vehicle is flat, and the door is of a sliding structure that opens outward.

23. The method according to claim 17, wherein the vehicle is a remotely monitored automated driving vehicle.
